(19) United States
(12) Patent Application Publication
(10) Pub. No.: US 2021/0063108 A1
(43) Pub. Date: Mar. 4, 2021

(54) Magnetic Firearm Mounts

(71) Applicant: Christopher Bryan Parsons, Cañon City, CO (US)

(72) Inventor: Christopher Bryan Parsons, Cañon City, CO (US)

(21) Appl. No.: 16/865,279

(22) Filed: May 1, 2020

Related U.S. Application Data
(60) Provisional application No. 62/894,518, filed on Aug. 30, 2019.

(51) Int. Cl. F41A 23/18; F41A 23/38; B60R 11/00

(52) U.S. Cl. CPC F41A 23/18; F41A 23/38; B60R 2011/0005; B60R 2011/007; B60R 11/00

(57) ABSTRACT

Devices for mounting firearms to dashboards and motorcycle handlebars, making them readily available to drivers, are provided. A magnetic firearm dash mount kit includes a cup ring, a ring, a round cap, and a fastener. The cup ring houses the ring magnet, which in turn surrounds the round cap. The fastener is inserted through a fastener hole of the case and a corresponding hole in the vehicle dash panel to secure the magnetic firearm mount to the vehicle dash panel. A magnetic firearm mount assembly for a motorcycle comprises a magnetic firearm mount, a clamp, and optionally a barrel mount. The magnet is strong enough to stably secure a variety of handheld pistols to the mount under bumpy driving conditions. The clamp is linked to the mount and is stably and releasably mount about a motorcycle handlebar. The barrel mount fits in the firearm barrel to further secure the firearm.

### RELATED APPLICATIONS

This application herein incorporated by reference and claims the benefit of my U.S. Provisional Patent Application Nos. 62/814,286, filed Mar. 5, 2019, and 62/894,518, filed Aug. 30, 2019, both entitled “Magnetic Firearm Mounts.”

### TECHNICAL FIELD

This invention relates to firearm mounts, and more particularly, to magnetic firearm mounts.

### BACKGROUND

Many armed travelers keep firearms in a dashboard compartment while traveling. When presented with a justifiable need to neutralize a threat, an owner loses precious time and risks driving distraction while reaching into the dash compartment to retrieve their firearm. What is needed is a safe and secure method and device for keeping firearms immediately available and within easy reach while traveling, thereby increasing the safety of security of the travelers as well as of the public protected by the heroic courage of these lawfully armed travelers.

Armed motorcycle riders frequently keep firearms on their holster or in a bag while traveling. They too need a safe and secure method and device for immediately accessing their firearms to protect the lives and safety of themselves and members of the threatened public.

### SUMMARY

In one embodiment, a magnetic firearm mount kit for a vehicle dash panel is provided that is easily, and with a minimum of potential defacement, mounted to the dash of a vehicle. The magnetic firearm mount kit comprises a cup ring, a ring magnet (or alternatively a magnetic cup ring), a round cap, and a fastener. The cup ring has at least a 3″ diameter, a bottom surface and an upper surface. The cup ring houses the ring magnet and defines a central aperture and a fastening hole that are each concentric with the ring magnet. The round cap, which may be formed of metal (including magnetizable metal such as iron), wood, or plastic, has a diameter that is nearly equal to a diameter of the magnet's central aperture and configured to be seated in the ring magnet's central aperture with a top surface flush with the magnet's upper surface. The fastener is configured to be inserted through the fastener hole of the case, and further through a corresponding hole in the vehicle dash panel, to secure the magnetic firearm mount to the vehicle dash panel.

In one implementation, the cup ring comprises the ring magnet, a ring and a case, which in combination makes it a magnetic cup ring. The ring surrounds the ring magnet so as to buffer the ring magnet from shocks. The case is defined by a base, a lip extending upwardly from a perimeter of the base, and a rim. The case defines a fastener hole that is concentric and coaxial with the case, wherein the ring magnet and ring are seated in the case with the lip extending around the ring.

In other implementations, the cup ring is replaced by a covered magnet or combination of magnets. In yet other implementations, the circular shape (or axial section) of the cup ring and other elements are replaced with other forms, such as an ellipse, oval, super-ellipse, egg shape, folium, square or other regular polygon, a rectangle or other irregular convex polygon, an irregular concave polygon, or a shape having some other arrangement of curved and/or straight segments (e.g., a sector).

In a particular implementation, the magnetic cup ring has at least a 70 mm diameter, a bottom surface and an upper surface, and defines the central aperture of the cup ring.

In one implementation, the cap has a thickness that is nearly equal to a thickness of the ring magnet minus a distance between a top surface of the fastener head and a base of the case when the fastener is fully inserted through the fastener hole of the case.

In another implementation, the round cap has a thickness approximately equal to a thickness of the ring magnet, the fastener has a countersunk flat head, a cap hole is defined in the round cap for receiving the fastener, and a countersunk section is defined about a top of the cap hole to receive the countersunk flat head of the fastener so that the fastener, when installed, is flush with the top of the cap hole. In one embodiment, a plurality of secondary magnets are embedded in the round cap.

In one embodiment, the magnetic firearm mount kit of claim 1 further comprises an elastic rubber or artificial elastomeric cover with a fastener hole, the cover configured to encompass the base, lip, and rim of the case and at least a top portion of the ring, wherein when the magnetic firearm mount is attached to the vehicle dash panel, it protects a firearm mounted thereon from being scratched by the case. In an alternative embodiment, a silicone coating is provided in place of a separate elastic cover. The silicone coating encompasses the base, lip, and rim of the case and at least a top portion of the ring.

The magnetic firearm mount kit may further comprise a round decal having an at least 68 mm diameter, wherein an attachment surface of the ring magnet and a top surface of the cap are flush. In one implementation, the decal is configured to be adhesively attached to at least the ring magnet and round cap, thereby securing the round cap inside the magnetic ring central aperture. In another implementation, the decal has a low-friction top surface that protects the magnet and prevents abrasion to or from the firearm when mounted or dismounted from the magnetic firearm mount. In an embodiment that includes both an elastic cover and a decal, the elastic cover and decal combined cover an entire outer surface area of the ring magnet and case to minimize abrasion between a magnetic firearm mount assembled from the kit and a firearm.

In one embodiment, the magnetic firearm mount kit further comprises a set of instructions that indicates a drill bit size for drilling a dash panel hole through the vehicle dash panel to receive the fastener; and a push-clip plug sized to fit into the dash panel hole when the magnetic firearm mount is removed from the vehicle.

Another embodiment of the invention provides a magnetic firearm mount for a vehicle dash panel, the magnetic firearm mount comprising a ring magnet, a ring surrounding the ring magnet, a second magnet, a case, and a fastener. The ring magnet, which is in one embodiment comprised of hard ferrites, has at least a 70 mm diameter and features a central aperture that is concentric with the ring magnet. The ring surrounds the ring magnet and is configured to buffer the ring magnet from shocks. A second magnet is, in one embodiment, a neodymium magnet and in the form of a disc or barrel, and in another embodiment, a ring magnet with a central aperture. The second magnet has a diameter that is nearly equal to a diameter of the magnet's central aperture and is configured to be seated in the ring magnet's central aperture with a top surface flush with the magnet's upper surface. The case is defined by a base, a lip extending upwardly from a perimeter of the base, and a rim. The case also defines a fastener hole that is concentric with the case. The ring magnet and ring are seated in the case with the lip extending around the ring. The fastener is configured to be inserted through the fastener hole of the case, and further through a corresponding hole in the vehicle dash panel, to secure the magnetic firearm mount to the vehicle dash panel. The magnetic firearm mount may also comprise a plug having a diameter that is nearly equal to a diameter of the second magnet's central aperture and configured to be seated in the second magnet's central aperture with a top surface flush with the second magnet's upper surface.

Another embodiment of the invention is a method of assembling and installing a magnetic firearm mount on a vehicle dash. The method comprises obtaining or creating a cup magnet formed by one of the two following processes: (a) centrally locating a ring magnet on a base of a cylindrically-shaped cup, placing adhesive between an axially-parallel surface of the ring magnet and an axially-parallel lip of the cup to form a ring around the magnet, between the magnet and the cup, and allowing the adhesive to cure; and (b) fitting a rubber or elastic ring around a ring magnet, inserting the ring and ring magnet into a cylindrically-shaped cup. The method further comprises installing a rubber or elastomeric cover over the cup magnet; inserting a wooden, plastic, metallic or magnetic cap into a central aperture of the ring magnet; covering the cup magnet and cap with a decal; and inserting a bolt or screw through holes formed in the cup, cover, and the vehicle dash and securing the cup magnet to the vehicle dash.

Another embodiment of the invention is a magnetic firearm mount assembly for a motorcycle. The assembly comprises a magnetic firearm mount, a clamp, and optionally a barrel mount. The magnet of the mount is strong enough to stably secure a variety of handheld pistols, at least 10 ounces in weight, to the mount under bumpy driving conditions that impose accelerations having a magnitude of as much as 5 g's to a base of the mount. The clamp is linked to the magnetic firearm mount and configured to stably mount and releasably mount the magnetic firearm mount to a motorcycle handlebar. The barrel mount is configured to fit within a barrel of a mounted firearm and thereby further secure the firearm to the mount.

### BRIEF DESCRIPTION OF THE DRAWINGS

The present disclosure may be better understood with reference to the following figures. Corresponding reference numerals designate corresponding parts throughout the figures, and components in the figures are not necessarily to scale.

It will be appreciated that the drawings are provided for illustrative purposes and that the invention is not limited to the illustrated embodiment. For clarity and in order to emphasize certain features, not all of the drawings depict all of the features that might be included with the depicted embodiment. The invention also encompasses embodiments that combine features illustrated in multiple different drawings; embodiments that omit, modify, or replace some of the features depicted; and embodiments that include features not illustrated in the drawings. Therefore, it should be understood that there is no restrictive one-to-one correspondence between any given embodiment of the invention and any of the drawings.

FIG. 1 is an exploded perspective view of one embodiment of a magnetic dash mount kit containing a cup magnet, a cap, a resilient cover, an assortment of fastening hardware, and a decal.

FIG. 2 is a perspective view of one embodiment of an assembled magnetic dash mount housed within the resilient cover.

FIG. 3 is a top view of one embodiment of an assembled magnetic dash mount sans the resilient cover.

FIG. 4 is a perspective view of a second embodiment of an assembled magnetic dash mount housed within the resilient cover, in which a bolt or screw extends through the cap.

FIG. 5 is a top view of the second embodiment of an assembled magnetic dash mount sans the resilient cover.

FIG. 6 is an exploded perspective view of an embodiment of a magnetic dash assembly, including three types of center caps or magnets, that reveals aspects of the assembly of the cup magnet.

FIG. 7 is a side cross-sectional view of the magnetic dash mount illustrating a thickness modification made to the cap to accommodate its placement over a bolt head.

FIG. 8 is a perspective view of an alternative embodiment of a cap in which a small cylindrical recess is formed in the bottom of the cap.

FIG. 9 is an exploded perspective view of a second embodiment of a magnetic dash assembly.

FIG. 10 is an exploded perspective view of a second embodiment of a magnetic dash assembly.

FIG. 11 is an exploded perspective view of a third embodiment of a magnetic dash assembly.

FIG. 12 is an exploded perspective view of a fourth embodiment of a magnetic dash assembly.

FIG. 13 illustrates the magnetic dash assembly installed on a vehicle dash.

FIG. 14 illustrates one embodiment of a magnetic motorcycle mount assembly.

FIG. 15 illustrates a handlebar mount utilized in the magnetic motorcycle mount assembly of FIG. 14.

FIG. 16 illustrates the magnetic motorcycle mount assembly of FIG. 14 installed on a motorbike and holding a pistol.

FIG. 17 is a closeup perspective view of the magnetic motorcycle mount assembly of FIG. 14.

FIG. 18 illustrates one embodiment of a supplemental barrel mount for use with the motorcycle mount assembly.

FIG. 19 illustrates the supplemental barrel mount used in conjunction with a magnetic mount to hold a gun.

### DETAILED DESCRIPTION

Any reference to “invention” within this document is a reference to an embodiment of a family of inventions, with no single embodiment including features that are necessarily included in all embodiments, unless otherwise stated. Furthermore, although there may be references to “advantages” provided by some embodiments, other embodiments may not include those same advantages, or may include different advantages. Any advantages described herein are not to be construed as limiting to any of the claims.

Specific quantities (e.g., spatial dimensions) may be used explicitly or implicitly herein as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

In describing preferred and alternate embodiments of the technology described herein, specific terminology is employed for the sake of clarity. Technology described herein, however, is not intended to be limited to the specific terminology so selected, and it is to be understood that each specific element includes all technical equivalents that operate similarly to accomplish similar functions.

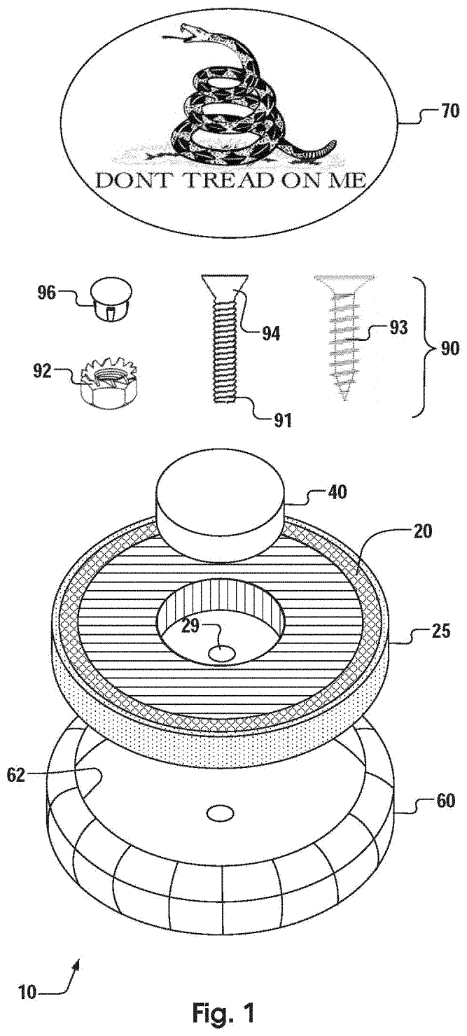

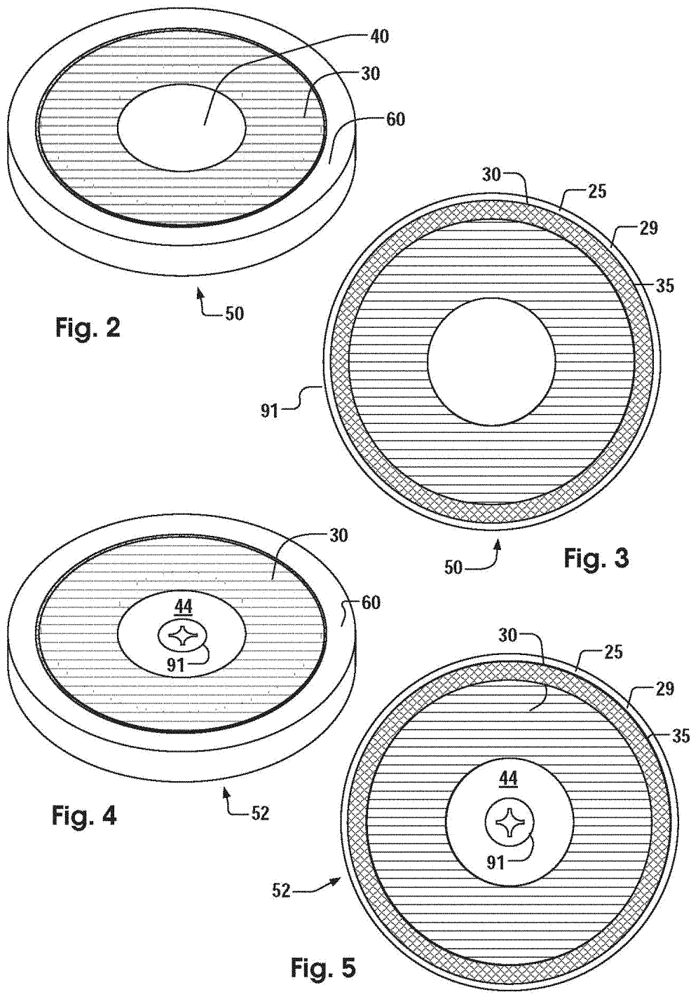

FIG. 1 is an exploded perspective view of one embodiment of a magnetic firearm mount kit 10 for a vehicle dash panel. The kit 10 comprises a cup magnet 20 that includes a ¼″ hole 29 that is concentric with an outer case 25 surrounding the cup magnet 20, a round cap 40 sized for a snug fit into the central aperture 32 of the magnet 30, a rubber or elastomeric cover 60 to surround the cup magnet 20, an assortment of fastening hardware 90, and a decal 70. The composition of the cup magnet 20 is described in connection with FIG. 2.

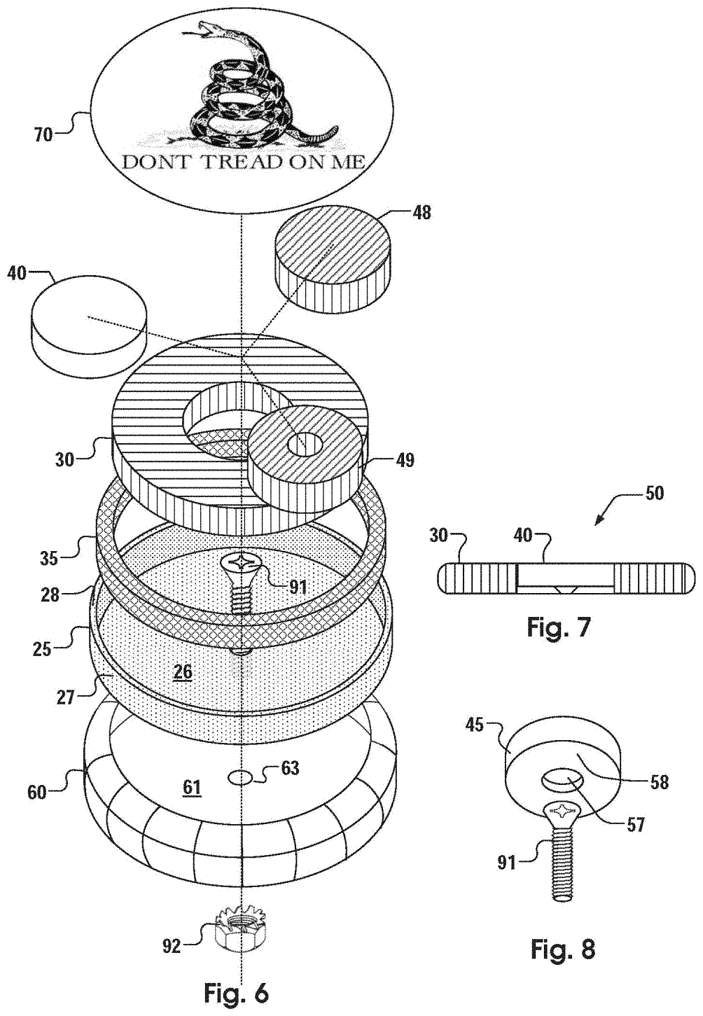

The round cap 40—illustrated with stippling—is cylindrically shaped and has a diameter approximately equal to that of the interior aperture 32 of the magnet. In various implementations, the round cap 40 is formed from wood, plastic, other polymers, ceramic, a composite, metal, or a combination thereof. The round cap 40 may be painted to help the decal 70 better adhere to the cap 40. In the embodiments of FIG. 8, the round cap 40 is replaced with a round cap 44 that includes a countersunk hole 42. The hole 42 is configured to receive the fastener 91 and to include a countersunk section 43 defined about a top of the cap hole 42 to receive the countersunk flat head 94 of the fastener 91 so that the fastener 91 is flush with the top of the cap hole 42. In the embodiments of FIGS. 6, 10 and 11, the round cap 40 may consist essentially only of either a disc magnet 48, another smaller ring magnet 49, or a disc 51 or 52 that holds one or more barrel magnets 53.

The assortment of hardware 90 comprises a bolt 91 with a flat, frustoconical (i.e., countersunk) head 94, a countersunk screw 93, a Keps K lock nut 92 comprising a hex nut pre-assembled with a free spinning external tooth lock washer, and a push-clip plug 96. The fastener 91 and 93 are configured to be inserted through the fastener hole 29 of the case 25, and further through a corresponding hole created in the vehicle dash panel, to secure the magnetic firearm mount to the vehicle dash panel. In another implementation, the nut is a bare nut but is accompanied by a washer and a lock washer. In other implementations, the nut is a flange nut, a nylon insert lock nut, a serrated face nut, a pair of jam nuts, a stover-equivalent lock nut, or any other type of torque-type or surface-bearing lock nut.

The push-clip plug 96—optionally neutrally colored to maximize compatibility—is provided to cover up the drilled dash hole if the magnetic firearm mount is removed and sized to fit into a ¼″ dash panel hole when the magnetic firearm mount is removed from the vehicle. Instructions accompanying the kit tell the customer to use a ¼″ drill to drill the dash panel hole. In another implementation, a push-type trim clip or retainer (not shown) is provided in place of the push-clip plug 16. Similar clips or retainers are nearly ubiquitous in vehicles as a means of attaching dash panels and other interior trim elements to the body or frame, and so the use of a similar clip or retainer may blend in better. Alternatively, the clip or retainer may be customized to display a symbol, phrase or slogan.

The decal 70 is round and comprises vinyl or other material selected to buffer the magnet 30 and prevent scratching of the firearm. The decal 70 has an adhesive backing. The decal 70 may feature a symbol, statement, logo, and/or commercial indicia. In one implementation, the decal 70 has an at least 68 mm diameter, and is designed to cover the ring magnet 30 and top surface of a flush cap 44. In one embodiment, the decal 70 is configured to be adhesively attached to at least the ring magnet 30 and round cap 40, thereby securing the round cap 40 inside the magnetic ring central aperture 41. Preferably, the decal 70 has a low-friction top surface that protects the magnet and substantially prevents abrasion to or from the firearm when mounted or dismounted from the magnetic firearm mount 50.

The elastic cover 60 has a fastener hole 62 and is configured to encompass the base 26, lip 27, and rim 28 of the case 25 and at least a top portion of the ring 35. When the magnetic firearm mount 50 is attached to the vehicle dash panel, it protects a firearm mounted thereon from being scratched by the magnetic firearm mount 50.

In one implementation, the kit is delivered to the customer with the elastomeric or rubber cover 60 already fit over the cup magnet 20. In another implementation, the customer is instructed to install the cover 60 over the cup magnet 20 after the cup magnet 20 and decal 70 are installed. Preferably, the decal 70 has a diameter that exceeds the diameter of the inside lip edge 62 of the cover 60 but is less than the diameter of the cup magnet 20. Advantageously, the combination of decal 70 and cover 60 both buffers the magnet 30 and minimizes scratching of the firearm when mounted on or dismounted from the mount 50.

FIG. 2 is a perspective view one embodiment of an assembled magnetic firearm mount 50 housed within the elastic cover 60, similar to what an assembly of the magnetic firearm mount kit 10 would look like before the decal 70 was attached. The assembled magnetic firearm mount 50 comprises a metal or optionally plastic cup 25, the ring magnet 30, an elastomeric or rubber seal ring or adhesive ring 35 (shown in cross-hatching) surrounding the ring magnet 30 to buffer it from the metal cup 25 and forces exerted on the metal cup 25, and the round cap 40. FIG. 3 is similar to FIG. 2 but does not depict the cover 60 in order to reveal the seal or ring 25 and the rim 29 of the cup 25.

In all of the drawings, the top and round side surfaces of ring magnet 30 are depicted with horizontal and vertical hatch lines, respectively, in order to distinguish the ring magnet 30 from the other elements. In embodiments that have one or more secondary magnets, the top surface of the secondary magnet is depicted with diagonal hatch lines.

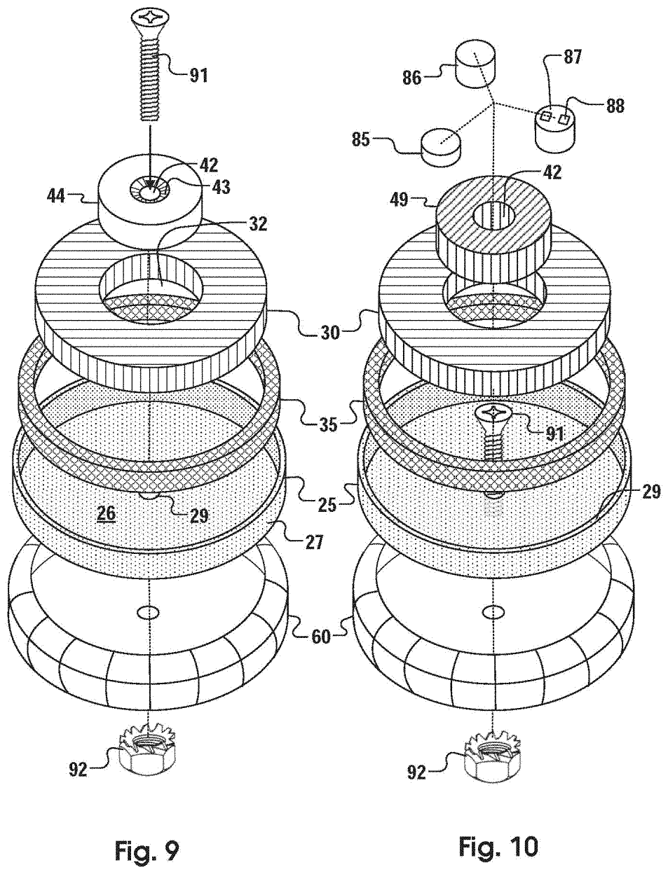

In one implementation, the case 25—which is preferably made of iron or steel but may alternatively be made of plastic, ceramic, a composite, or other material—is defined by a base 26, a lip 27 extending upwardly from a perimeter of the base 26, and a rim 28. Furthermore, the case 25 defines a fastener hole 29 (FIG. 9) that is concentric with the case 25. The ring magnet 30 and ring 35 are seated in the case 25 with the lip 27 of the case 25 extending around the ring 35, which in one implementation is made of polyurethane or epoxy.

In one implementation, the ring magnet 30 is a ceramic magnet comprised of hard ferrites and has at least a 70 mm (or approximately a 3″) diameter. A central aperture 32, approximately 32-33 mm in diameter, is defined within the ring magnet 30 that is concentric with the ring magnet 30. The round cap 40 (or disc magnet 48 or ring magnet 49 of FIG. 6) has a diameter that is nearly equal to the diameter of the central aperture 32 (i.e., also about 32-33 mm) and is configured to be seated in the ring magnet's central aperture with a top surface flush with the magnet's upper, decal-facing surface.

FIGS. 4 and 5 are a perspective and top view of a second embodiment of an assembled magnetic dash mount. In this embodiment, unlike that of FIGS. 2 and 3, the bolt or screw extends through the round cap 44. In order to enable the bolt or screw head 94 to be flush with the cap 44, the hole 42 in the cap 44 is countersunk, creating a countersunk frustoconical recess 43 (FIG. 9). FIG. 9 is an exploded perspective view of this second embodiment.

FIG. 6 is an exploded perspective view of three embodiments (in one) of a magnetic dash assembly, including three types of center caps or magnets. Generally, FIG. 6 reveals aspects of the assembly of the cup magnet 20. In the first embodiment, like that of FIG. 1, the round cap 40 would be provided for insertion into the central aperture 32. In the second embodiment, the round cap 40 is replaced with a secondary disc magnet 48. In the third embodiment, the round cap 40 is replaced with a secondary ring magnet 49. In both the second and third embodiments, the secondary magnet 48 or 49 is installed into the central aperture 48 with a polarity opposite that of the (primary) ring magnet 30. In one implementation, the secondary ring magnet 49 or 49 is made of a powerful magnetic material such as neodymium (a rare earth mineral) and the primary ring magnet 30 is made of a less powerful magnetic material such as hard ferrite (ceramic). Advantageously, this combination not only ensures that the overall magnetic mount 50 isn't excessively powerful, but also preserves a large footprint for placing a decal 70 that promotes a brand or exhibits a belief system.

FIG. 7 is a side cross-sectional view of a magnetic dash mount 50 according to the first embodiment of FIG. 6 illustrating a thickness modification made to the cap 40 to accommodate its placement over a bolt head 94. In one implementation, the ring magnet 30 has a thickness of approximately 1 cm, and when seated in the case 25 has a top surface that is flush with the rim 28 of the case 25 and the top of the ring 35. Because the head 94 of the bolt 91 sticks above the base 26 by about 2-3 mm, the cap 40 is formed with a thickness that is nearly equal to a thickness of the ring magnet 30 minus a distance between a top surface of the fastener head 94 and a base 26 of the case 25 when the fastener 91 is fully inserted through the fastener hole 29 of the case 25. In this example, the cap 40 is fabricated with a thickness of about 6-7 mm. It will be understood that the distance a bolt head 94 sticks above the base 26 is a function of the bolt specifications and the diameter of the fastener hole 29. Accordingly, the bolt or screw head 94, case aperture 29, and cap 40 are respectively dimensioned so that when assembled, the cap 40 is flush with the upper, decal-facing surface of the magnet 30.

FIG. 8 is a perspective view looking up of an alternative embodiment of a cap 44 in which a small cylindrical counterbore 57 is formed in the bottom of the cap 44. In this embodiment, unlike FIG. 7, the cap 44 has a width approximately the same as the width of the magnet 30. The counterbore 57 fits around the head 94 of the bolt 91 and allows the bottom 58 of the cap 44 to rest on the base 26 with the top of the cap 44 flush with the upper, decal-facing surface of the magnet 30.

FIGS. 10-12 illustrate three distinct alternative embodiments of the magnetic dash assembly. In FIG. 10, the cap 40 is replaced with another ring magnet 49. The second, inner magnet 49 is preferably installed in the primary magnet aperture 32 so that the inner magnet 49's polarity is oriented opposite the primary magnet's polarity. In one implementation, the second magnet 49 comprises neodymium.

This second, inner ring magnet 49 defines its own cylindrical aperture 42, into which a plug 85, 86, or 87 is provided to be inserted into the aperture 42. In one implementation, the bolt or screw head 94, case aperture 29, and plug 85, 86, or 87 are respectively dimensioned so that the plug 86 has a diameter that is nearly equal to a diameter of the second magnet's central aperture 41 and configured to be seated in the second magnet's central aperture 42 with a top surface flush with the second magnet 49's upper, decal-facing surface. The plug 85 has a thickness that is nearly equal to a thickness of the ring magnet 30 minus a distance between a top surface of the fastener head 94 and a base 26 of the case 25 when the fastener 91 is fully inserted through the fastener hole 29 of the case 25. The plugs 86 and 87 follow the same relationship but are depicted thicker than plug 85 to signify the use of a fastener 91 with a shallower head 94. Plug 87 includes indentions 88 to receive the tips of a tweezers or very small pliers to facilitate removal of the plug 87 and access to fastener 91.

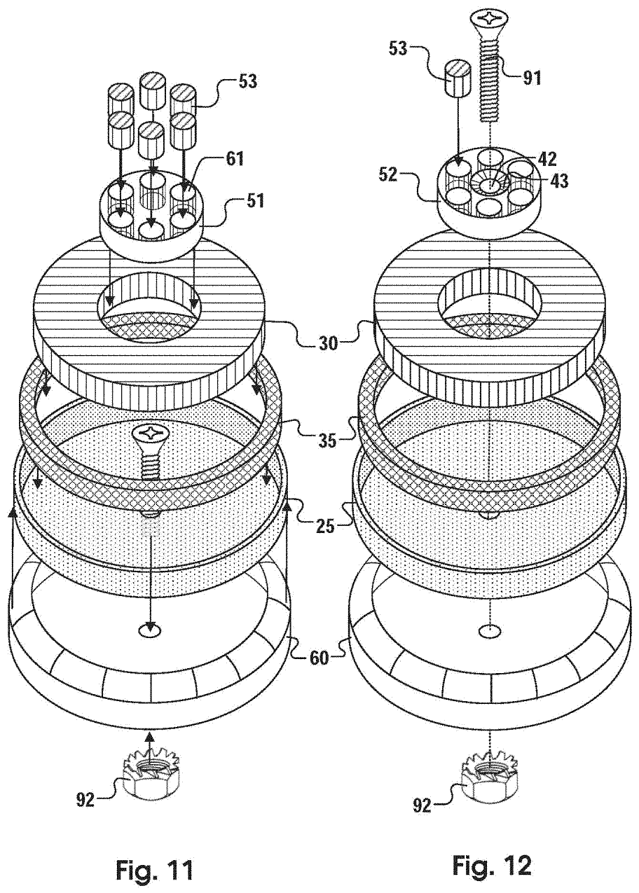

In FIG. 11, the cap 40 is replaced with a barrel magnet holder 51 that houses a plurality of secondary magnets—preferably neodymium—oriented in a ring that is concentric with the holder 51. In one implementation, the planar surface of the holder 51 resembles a pistol revolver in that it has six magnets symmetrically arranged around the center. A plurality of (e.g., 6) disc or barrel magnets 53 are embedded into the symmetrically arranged cylindrical apertures 61 of the holder 51. In one implementation, the magnets 53 are installed in the holder 51 with alternating polarities. In another embodiment, the magnets 53 are installed in the holder 51 with the same polarity, but whose polarities are opposite of the polarity of the ring magnet 30. It will be understood that there may be some opposition between the magnetic fields produced within the barrel magnet holder 51 and the magnetic field produced by the ring magnet 30.

FIG. 12 is like FIG. 11 except that the holder—here designated with the reference number 52—also provides an aperture 42 and countersunk region 43 for receiving a frustoconical fastener head 94.

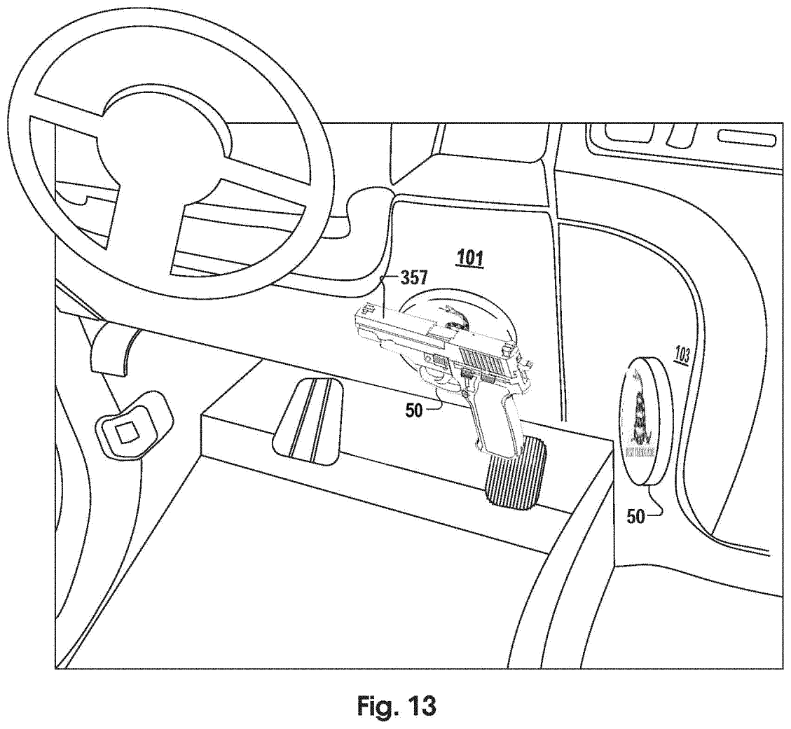

FIG. 13 illustrates two suitable locations for installing the magnetic dash mount on a vehicle dash panel 101 or dash console panel 103. Other potentially suitable places include directly underneath the steering wheel or under the steering wheel column. Any selected location is within the scope of the present invention. When selecting an installation point, it is important to drill the hole in a region that provides sufficient space for the firearm that the customer intends to carry in the vehicle, and where it is unlikely to be knocked off by the customer when operating or getting in and out of the vehicle.

To assemble and install the magnetic firearm mount to a vehicle dash panel, a customer is instructed to drill a ¼″ hole through a dash panel by or below the steering wheel or covering a side of the middle console of a vehicle. The customer is also instructed to assemble the kit components 10, insert the bolt 91 or screw 93 through the appropriate apertures—which at least include the case aperture 29, the cover aperture 63, and the drilled dash hole—and fasten the nut (if the fastener is a bolt) to the bolt 91.

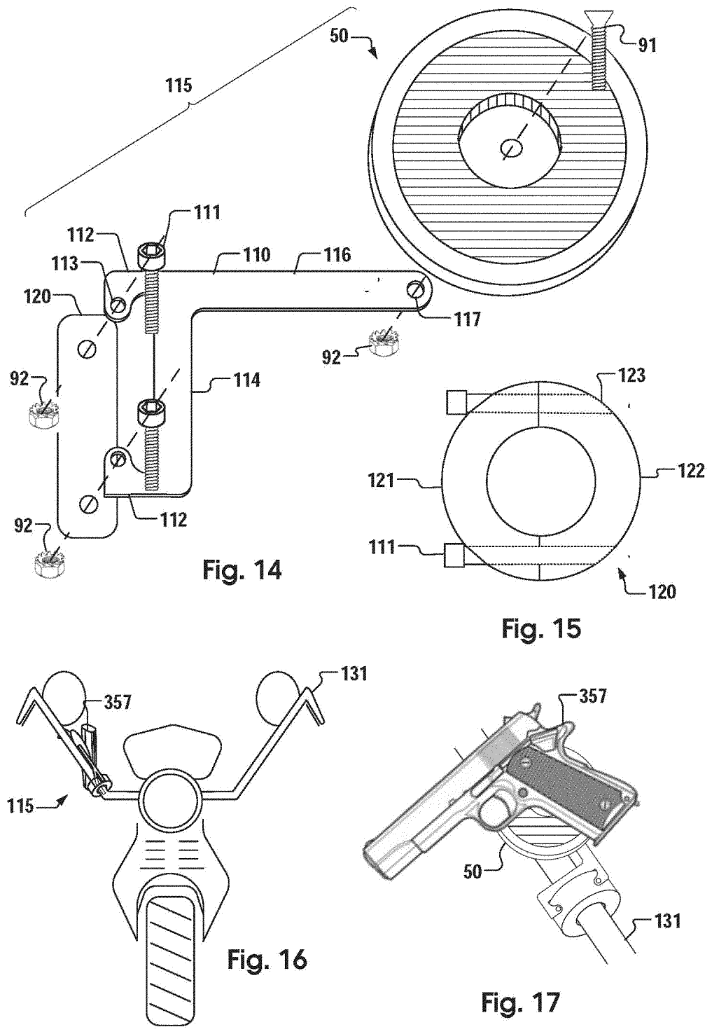

FIGS. 14-19 illustrate adaptations of the magnetic dash mount assembly for use on a motorcycle. In FIGS. 14 and 15, an embodiment of a handlebar magnetic gun mount assembly 115 comprises a magnetic firearm mount 50, a tube clamp 120, a bracket 110, bolts 111 for mounting the bracket 110 to the tube clamp 120 that also serve to tighten the tube clamp 120 about a handlebar 131, and nuts 92 for fastening the bolt.

It is emphasized that many different types of brackets and clamps would be suitable for use with the magnetic firearm mount 50, and that the embodiment disclosed is merely one of many possible enabling brackets for the handlebar magnetic gun mount assembly 115. In this embodiment, the clamp 120 comprises two metal, rubber, or polymeric half-rings 121, 123 that feature seats (not shown) and through-holes 123 for receiving the bolts 111 and nuts 92. The bracket 110 comprises two hands 112 that reach on either side of the tube clamp 120 to fit within the bolt-receiving seats of the tube clamp 120, two apertures 113 within those hands 112 to receive and be fastened by the bolts 111, a lateral section or segment 114 configured to run along a side of the clamp 120 and join the two hands 112, a longitudinal section or segment 116 that extends outwardly from the lateral section or segment 114, and an aperture 117 in the end of the longitudinal section or segment 116 for receiving a bolt 91 to secure the magnetic firearm mount 50 to the bracket 110.

FIG. 16 illustrates the magnetic motorcycle mount assembly 115 installed on a motorbike and holding a pistol 357. FIG. 17 is a closeup perspective view of the magnetic motorcycle mount assembly 115 on a handlebar 131.

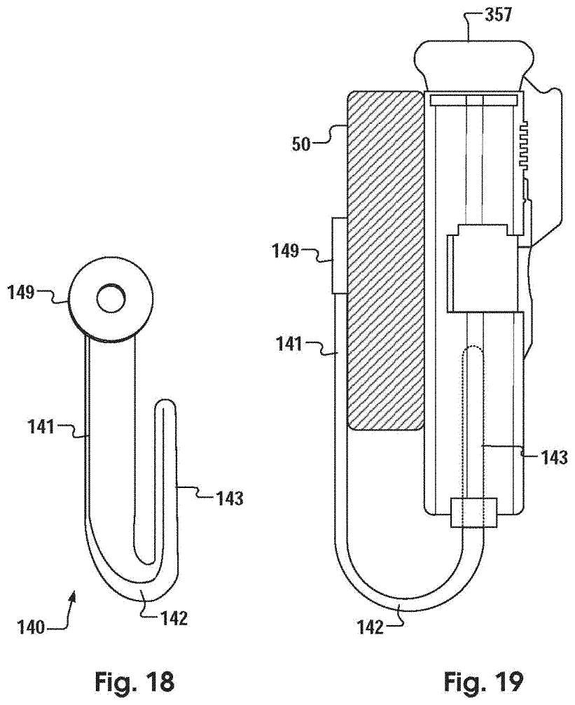

FIG. 18 illustrates one embodiment of a supplemental barrel mount 140 for use with the motorcycle mount assembly 115. A back plate 141 of the barrel mount 140 optionally welded to or otherwise attached to a washer 149 that mounts between the bracket 110 and the magnetic motorcycle mount assembly 115. A loop 142 or other connecting section or segment joins the back plate 141 to the barrel-mounting rod 143. The barrel-mounting rod 143 is configured to fit within a barrel of a firearm 357 and help the magnetic motorcycle mount assembly 115 to secure the firearm 357. FIG. 19 illustrates the supplemental barrel mount 140 used in conjunction with a magnetic mount 50 to hold the firearm 357. The rod 143 ensures that even if the motorcycle and/or magnetic motorcycle mount assembly 115 is subjected to a jarring shock, the rod 143 will substantially prevent the pistol from moving in any direction other than up. This safeguard, in combination with the strong magnetism of the magnetic firearm mount 50 and the force of gravity, ensures that—except in the most extreme situations—that the firearm 357 will not come crashing down to the ground, much less (given the gun's safety) going off and wounding somebody.

Different embodiments of the supplemental barrel mount 140 are envisioned for different types of firearms 357. In one embodiment, the barrel-mounted rod 143 is sized to support pistols with barrel lengths in a range comprising more than X % (e.g., 90%) of sold pistols, while keeping the portion of the gun frame that surrounds the gun action against a diameter of the magnetic firearm mount 50. In another embodiment, the barrel-mounted rod 143 is sized to support longer-barreled firearms such as AR-15s, AK-47s, and M16s while keeping the portion of the gun frame that surrounds the gun action against a diameter of the magnetic firearm mount 50.

In both the dash mount and motorcycle mount embodiments, it is desirable to choose magnets having a pull strength great enough to stably secure a range of common firearms under a variety of driving circumstances, including speed bumps, potholes, and rough terrain. Based on information and belief, modern vehicles equipped with suspensions can be expected to deliver modest g forces to passengers seated therein when driving at high speeds over speed bumps. A force as high as 5 g's would be very unusual and unexpected. Accordingly, in one embodiment, the primary magnet is selected to have a strength sufficient to stably secure a variety of handheld pistols, at least 10 ounces in weight (most pistols weigh at least this much), to the mount under bumpy driving conditions that impose accelerations having a magnitude of as much as 5 g's to a base of the mount. Based on information and belief, a ceramic magnet with at least an estimated 50 pounds of pull strength would meet these standards for a variety of firearms. Such pull strengths would be excessive (i.e., it would be difficult to remove the pistol from the magnet) if the entirety of the gun-contacting planar surface of the magnet were in direct contact with the pistol. But the surface area of a pistol coming into contact with the magnet will typically be substantially less.

Another motorcycle mount embodiment includes a suspension, such as a spring, hydraulics, cushioning, or a magnetic cushion to attenuate jolts and the associated g's transferred from the base of the magnetic firearm mount to the magnet of the magnetic firearm mount itself.

It will be understood that many modifications could be made to the embodiments disclosed herein without departing from the spirit of the invention. For example, the circular shape (or axial section) of the ring magnet and other cooperating elements of the kit are replaced with other forms, such as an ellipse, oval, super-ellipse, egg shape, folium, square or other regular polygon, rectangle or other irregular convex polygon, irregular concave polygon, or a shape having some other arrangement of curved and/or straight segments (e.g., a sector). These other embodiments fall within the scope of the invention except and only to the extent they are disclaimed by the clear language of the claims.

As another example, the provision of kits 10 that are like that shown in FIG. 1 but that substitute caps 48, 49, 51, or 52, that substitute a screw 93 for a bolt 91, that provide a screw 93 or bolt 91 with a different head 94, and/or that provide components made of different shapes or materials, or that incorporate any of the elements of FIGS. 14-19, are envisioned embodiments that fall within the scope of the invention provided that the language of the claims so allows.

Having thus described exemplary embodiments of the present invention, it should be noted that the disclosures contained in the drawings are exemplary only, and that various other alternatives, adaptations, and modifications may be made within the scope of the present invention. Accordingly, the present invention is not limited to the specific embodiments illustrated herein, but is limited only by the following claims.

I claim:

1. A magnetic firearm mount kit for a vehicle dash panel, the magnetic firearm mount kit comprising:
a cup ring having at least a 3″ diameter, having a bottom surface and an upper surface, housing a ring magnet, and defining a central aperture and a fastening hole that are each concentric with the ring magnet;
a round cap having a diameter that is nearly equal to a diameter of the magnet's central aperture and configured to be seated in the ring magnet's central aperture with a top surface flush with the magnet's upper surface; and
a fastener configured to be inserted through the fastener hole of the case, and further through a corresponding hole in the vehicle dash panel, to secure the magnetic firearm mount to the vehicle dash panel.

2. The magnetic firearm mount kit of claim 1, wherein the cup ring comprises:
the ring magnet, which has at least a 70 mm diameter, a bottom surface and an upper surface, and defines the central aperture of the cup ring;
a ring that surrounds the ring magnet configured to buffer the ring magnet from shocks; and
a case defined by a base, a lip extending upwardly from a perimeter of the base, a rim, and defining a fastener hole that is concentric with the case, wherein the ring magnet and ring are seated in the case with the lip extending around the ring.

3. The magnetic firearm mount kit of claim 1, wherein the round cap is formed from wood or plastic.

4. The magnetic firearm mount kit of claim 1, wherein the cap has a thickness that is nearly equal to a thickness of the ring magnet minus a distance between a top surface of the fastener head and a base of the case when the fastener is fully inserted through the fastener hole of the case.

5. The magnetic firearm mount kit of claim 1, wherein:
the round cap has a thickness approximately equal to a thickness of the ring magnet;
the fastener has a countersunk flat head;
a cap hole is defined in the round cap for receiving the fastener; and
a countersunk section is defined about a top of the cap hole to receive the countersunk flat head of the fastener so that the fastener, when installed, is flush with the top of the cap hole.

6. The magnetic firearm mount kit of claim 1, further comprising an elastic cover with a fastener hole, the cover configured to encompass the base, lip, and rim of the case and at least a top portion of the ring, wherein when the magnetic firearm mount is attached to the vehicle dash panel, it protects a firearm mounted thereon from being scratched by the case.

7. The magnetic firearm mount kit of claim 1, wherein the elastic cover comprises rubber or an artificial elastomer.

8. The magnetic firearm mount kit of claim 7, further comprising a round decal having an at least 68 mm diameter, wherein an attachment surface of the ring magnet and a top surface of the cap are flush, wherein the elastic cover and decal combined cover an entire outer surface area of the ring magnet and case to minimize abrasion between a magnetic firearm mount assembled from the kit and a firearm.

9. The magnetic firearm mount kit of claim 1, further comprising:
a set of instructions that indicates a drill bit size for drilling a dash panel hole through the vehicle dash panel to receive the fastener; and
a push clip, retainer, or plug sized to fit into the dash panel hole when the magnetic firearm mount is removed from the vehicle.

10. The magnetic firearm mount of claim 1, further comprising a plurality of secondary magnets embedded in the round cap.

11. A magnetic firearm mount for a vehicle dash panel, the magnetic firearm mount comprising:
a ring magnet having at least a 70 mm diameter and a central aperture that is concentric with the ring magnet;
a ring surrounding the ring magnet configured to buffer the ring magnet from shocks;
a second magnet having a diameter that is nearly equal to a diameter of the magnet's central aperture and configured to be seated in the ring magnet's central aperture with a top surface flush with an upper surface of the ring magnet;
a case defined by a base, a lip extending upwardly from a perimeter of the base, a rim, and defining a fastener hole that is concentric with the case, wherein the ring magnet and ring are seated in the case with the lip extending around the ring; and
a fastener configured to be inserted through the fastener hole of the case, and further through a corresponding hole in the vehicle dash panel, to secure the magnetic firearm mount to the vehicle dash panel.

12. The magnetic firearm mount of claim 1, wherein the ring magnet is comprised of hard ferrites.

13. The magnetic firearm mount of claim 1, wherein the ring magnet is a ferrite magnet and the second magnet is a neodymium magnet.

14. The magnetic firearm mount of claim 1, wherein the second magnet is a disc or barrel magnet.

15. The magnetic firearm mount of claim 1, wherein the second magnet is also a ring magnet with a central aperture.

16. The magnetic firearm mount of claim 15, further comprising a plug having a diameter that is nearly equal to a diameter of the second magnet's central aperture and configured to be seated in the second magnet's central aperture with a top surface flush with the second magnet's upper surface.

17. A magnetic firearm mount assembly for a motorcycle, comprising:
a magnetic firearm mount having a magnet strong enough to stably secure a variety of handheld pistols, at least 10 ounces in weight, to the mount under bumpy driving conditions that impose accelerations having a magnitude of as much as 5 g's to a base of the mount; and
a clamp linked to the magnetic firearm mount and configured to stably mount and releasably mount the magnetic firearm mount to a motorcycle handlebar.

18. The magnetic firearm mount assembly for a motorcycle, further comprising a barrel mount configured to fit within a barrel of a mounted firearm and thereby further secure the firearm to the mount.
